(19) United States
(12) Patent Application Publication
(10) Pub. No.: US 2009/0216625 A1
(43) Pub. Date: Aug. 27, 2009

(54) Systems and Methods for Automated Identification and Evaluation of Brand Integration Opportunities in Scripted Entertainment

(76) Inventors: Adam Jeffrey Erlebacher, New York, NY (US); Gregory Adam Neichin, Santa Monica, CA (US)

Correspondence Address: CHOATE, HALL & STEWART LLP, TWO INTERNATIONAL PLACE, BOSTON, MA, 02110, US

(21) Appl. No.: 12/393,392

(22) Filed: Feb. 26, 2009

Related U.S. Application Data
(60) Provisional application No. 61/031,747, filed on Feb. 27, 2008.

(51) Int. Cl. G06Q 10/00; G06Q 50/00

(52) U.S. Cl. 705/10

(57) ABSTRACT

A system for identifying and evaluating brand integration opportunities within scripted entertainment includes a script parser, an evaluation component, and a portfolio optimization component. The script parser receives at least one portion of a script and identifies a brand integration opportunity within the received at least one portion of the script. The evaluation component receives the at least one portion of the script and predicts a level of success of a production including the at least one portion of the script. The portfolio optimization component generates a portfolio including an identification of the script, responsive to the generated prediction of the level of success and the identified brand integration opportunity.

### FIELD OF THE INVENTION

The present disclosure relates to methods and systems for identifying brand integration opportunities in scripted entertainment. In particular, the present disclosure relates to systems and methods for automated identification and evaluation of brand integration opportunities in scripted entertainment.

### BACKGROUND OF THE INVENTION

Currently, the brand integration industry is driven by personal relationships between marketers and producers and the workflow of a brand integration transaction—discovery, evaluation, negotiation, and execution—remains a primarily manual process. Generally, once a brand integration opportunity is discovered, evaluated and approved, marketers enter into negotiations with the content producers to consummate a transaction. Once the negotiators reach agreement, the brand integration is executed. Execution involves not only the marketer paying consideration to the producer (in the form of financial payment and/or in-kind product), but also ensuring that the product, service, or idea is successfully integrated into said scripted entertainment. However, every integration is unique and normally requires intensive communication between the marketer and producer, particularly during the negotiation and execution stages.

This model, which typically relies exclusively on manual filtering or on one agency's client relationships during the discovery and evaluation stage of the brand integration process, is becoming increasingly inefficient as the amount of content, and thus the number of brand integration opportunities, increases. Due to an increasingly cluttered advertising environment and with limited choices to reach potential customers, marketers are hungry to access more integration opportunities. Similarly, producers are unable to maximize the full value of their integration inventory by working solely through individual agencies that only have access to a small number of brand marketers.

### BRIEF SUMMARY OF THE INVENTION

In one aspect, the system automatically identifies brand integration opportunities within scripts, predicts the success of those brand integration opportunities, and assembles risk-adjusted portfolios of brand integration opportunities to optimize marketer spending on brand integrations.

In another aspect, a system for identifying and evaluating brand integration transactions includes a user profile database that stores marketer and producer profile information; a script database that stores producers' text- or audio-based manuscripts (“scripts”); a script parser that uses natural language processing and other automated techniques to identify brand integration opportunities (“product placements”) in scripts, as well as automated techniques for editing identified opportunities; an evaluation component applying an algorithm that uses natural language parsing techniques, questionnaire answers, and historical performance data (e.g. box office revenue, internet “views”, etc.) to predict the popularity of a script; an optimization component applying algorithms based on finance theory and generating risk-diversified product placement portfolios for marketers based on each marketer's risk preferences or for producers based on producer preferences; an auction-based component that facilitates the buying, selling, trading, or optioning of product placements; a web-based graphical user interface for marketers and producers to interact with the system; a notification engine that alerts marketers or producers about events in the system; and a messaging system that facilitates communication between producers and marketers. The system may include one, some, or all of the above components.

In one aspect, a system for parsing a script to identify brand integration opportunities within scripted entertainment includes a lexical analysis component, a syntactic analysis component, and a semantic parser. The lexical analysis component receives at least one portion of a script and generates at least one token, responsive to an analysis of the received at least one portion of the script. The syntactic analysis component receives the generated token and applies a rule to the generated token to format the generated token for parsing. The semantic parser applies a rule to the formatted token and identifies a product placement opportunity within the analyzed at least one portion of the script.

In another aspect, a method for parsing a script to identify brand integration opportunities within scripted entertainment includes receiving, by a lexical analysis component, at least one portion of a script and generating at least one token, responsive to an analysis of the received at least one portion of the script. The method includes receiving, by a syntactic analysis component, the generated token and applying a rule to the generated token to format the generated token for parsing. The method includes applying, by a semantic parser, a rule to the formatted token and identifying a product placement opportunity within the analyzed at least one portion of the script.

In still another aspect, a method for parsing a script to predict a level of success of a production of scripted entertainment includes receiving, by an evaluation component executing on a computing device, a portion of a script. The method includes analyzing, by the evaluation component, the portion of the script using a natural language processing technique. The method includes analyzing, by the evaluation component, data associated with the portion of the script. The method includes generating, by the evaluation component, a prediction of a level of success of a production based on the script, responsive to the analyses of the portion of the script and of the associated data. The method includes transmitting, by the evaluation component, to a portfolio generation component, the generated prediction. In one embodiment, the method includes receiving, by the portfolio generation component, an identification of a brand integration opportunity within the portion of the script. In another embodiment, the method includes generating, by the portfolio generation component, a portfolio including an identification of the script responsive to the received prediction of the level of success and the received identification of the brand integration opportunity.

In one aspect, a system for identifying and evaluating brand integration opportunities within scripted entertainment includes a script parser, an evaluation component, and a portfolio optimization component. The script parser receives at least one portion of a script and identifies a brand integration opportunity within the received at least one portion of the script. The evaluation component receives the at least one portion of the script and predicts a level of success of a production including the at least one portion of the script. The portfolio optimization component generates a portfolio including an identification of the script responsive to the generated prediction of the level of success and the identified brand integration opportunity.

In another aspect, a method for generating a portfolio of product placement opportunities includes receiving, by a portfolio optimization component executing on a computing device, from a user, at least one identification of a user preference for a type of product placement opportunities. The method includes retrieving, by the portfolio optimization component, from a database of product placement opportunities that have been analyzed for potential success, at least one identification of a product placement opportunity satisfying the at least one identification of the user preference. The method includes generating, by the portfolio optimization component, a portfolio storing the at least one identification of the product placement opportunities. The method includes transmitting, by the portfolio optimization component, to the user, a notification of the generation of a portfolio.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of the system comprising client machines in communication with the system;

FIG. 1B is a block diagram depicting one embodiment of the system and its components in connection with the methods and systems described herein;

FIG. 2A is a block diagram depicting one embodiment of a system for identifying and evaluating brand integration transactions in scripted entertainment;

FIG. 2B is a block diagram depicting one embodiment of a script parser in a system for identifying and evaluating brand integration transactions in scripted entertainment;

FIG. 2C is a block diagram depicting one embodiment of an evaluation component in a system for identifying and evaluating brand integration transactions in scripted entertainment;

FIG. 2D is a block diagram depicting one embodiment of a portfolio optimizer in a system for identifying and evaluating brand integration transactions in scripted entertainment;

FIG. 2E is a screen shot depicting one embodiment of a graphical user interface in a system for identifying and evaluating brand integration transactions in scripted entertainment;

FIG. 2F is a block diagram depicting one embodiment of a notification engine in a system for identifying and evaluating brand integration transactions in scripted entertainment;

FIG. 2G is a block diagram depicting one embodiment of a messaging system facilitating communication between content producers and marketers;

FIG. 2H is a block diagram depicting an embodiment of a system for identifying and evaluating brand integration transactions in scripted entertainment;

FIG. 3A is a flow diagram depicting one embodiment of a method for parsing a script to identify a brand integration opportunity within scripted entertainment;

FIG. 3B is a flow diagram depicting one embodiment of a method for parsing a script to predict a level of success of a scripted entertainment based on the script;

FIG. 3C is a flow diagram depicting one embodiment of a method for generating a portfolio of product placement opportunities;

FIG. 4A is a flow diagram depicting one embodiment of a method for contacting, by a producer, a marketer, regarding a brand integration project;

FIG. 4B is a flow diagram depicting one embodiment of a method for contacting, by a marketer, a producer, regarding a brand integration project; and

FIG. 4C is a flow diagram depicting one embodiment of a method for automatically identifying product placements in scripts and notifying marketers of available product placement opportunities.

### DETAILED DESCRIPTION OF THE INVENTION

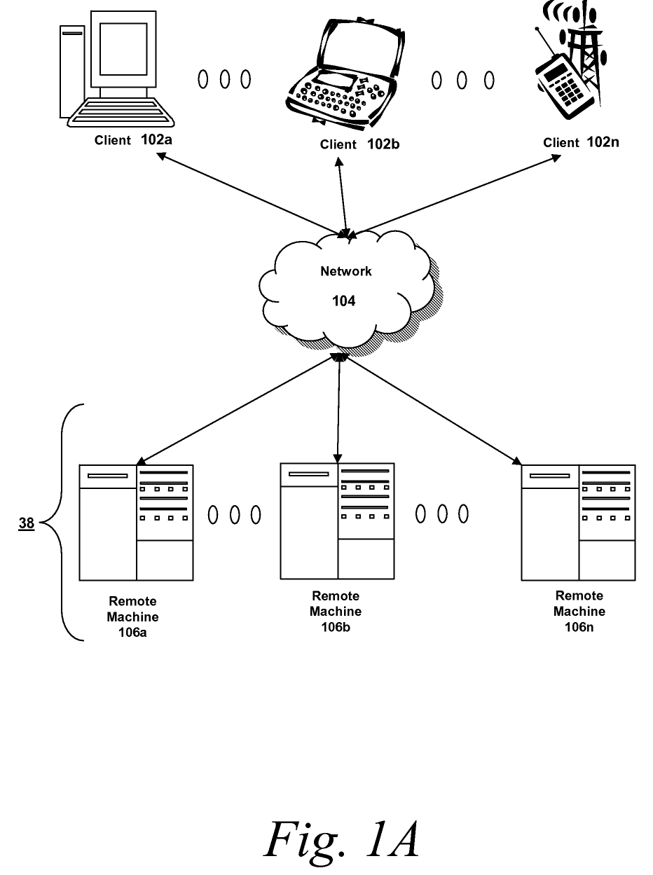

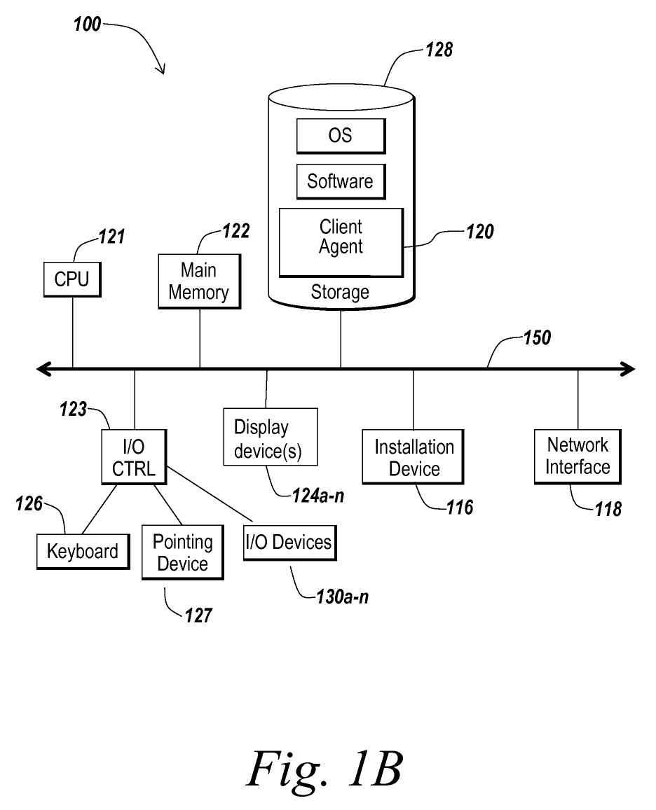

Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104.

The servers 106 may be geographically dispersed from each other or from the clients 102 and communicate over a network 104. The network 104 can be a local-area network (LAN), such as a company Intranet, a metropolitan area network (MAN), or a wide area network (WAN), such as the Internet or the World Wide Web. The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

A server 106 may be referred to as a file server, application server, web server, proxy server, or gateway server. In one embodiment, the server 106 provides functionality of a web server. In some embodiments, the web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the SUN JAVA web server products provided by Sun Microsystems, of Santa Clara, Calif., or the BEA WEBLOGIC products provided by BEA Systems, of Santa Clara, Calif.

The clients 102 may be referred to as client nodes, client machines, endpoint nodes, or endpoints. In some embodiments, a client 102 has the capacity to function as both a client node seeking access to resources provided by a server and as a server providing access to hosted resources for other clients 102a-102n. A client 102 may execute, operate or otherwise provide an application, which can be any type and/or form of software, program, or executable instructions such as any type and/or form of web browser, web-based client, client-server application, an ActiveX control, or a Java applet, or any other type and/or form of executable instructions capable of executing on client 102. The application can use any type of protocol and it can be, for example, an HTTP client, an FTP client, an Oscar client, or a Telnet client.

The client 102 and server 106 may be deployed as and/or executed on any type and form of computing device, such as a computer, network device or appliance capable of communicating on any type and form of network and performing the operations described herein. FIG. 1B depicts a block diagram of a computing device 100 useful for practicing an embodiment of the client 102 or a server 106. As shown in FIG. 1B, each computing device 100 includes a central processing unit 121, and a main memory unit 122. As shown in FIG. 1B, a computing device 100 may include a visual display device 124, a keyboard 126 and/or a pointing device 127, such as a mouse.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

The computing device 100 may include a network interface 118 to interface to a Local Area Network (LAN), Wide Area Network (WAN) or the Internet through a variety of connections including, but not limited to, standard telephone lines, LAN or WAN links (e.g. 802.11, T1, T3, 56kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIG. 1B typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others. A server 106 and a client 102 may be heterogeneous, executing different operating systems.

In some embodiments, the computing device 100 may have different processors, operating systems, and input devices consistent with the device. For example, in one embodiment the computing device 100 is a TREO 180, 270, 1060, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the iM1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry PEARL 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Computer of Cupertino, Calif.

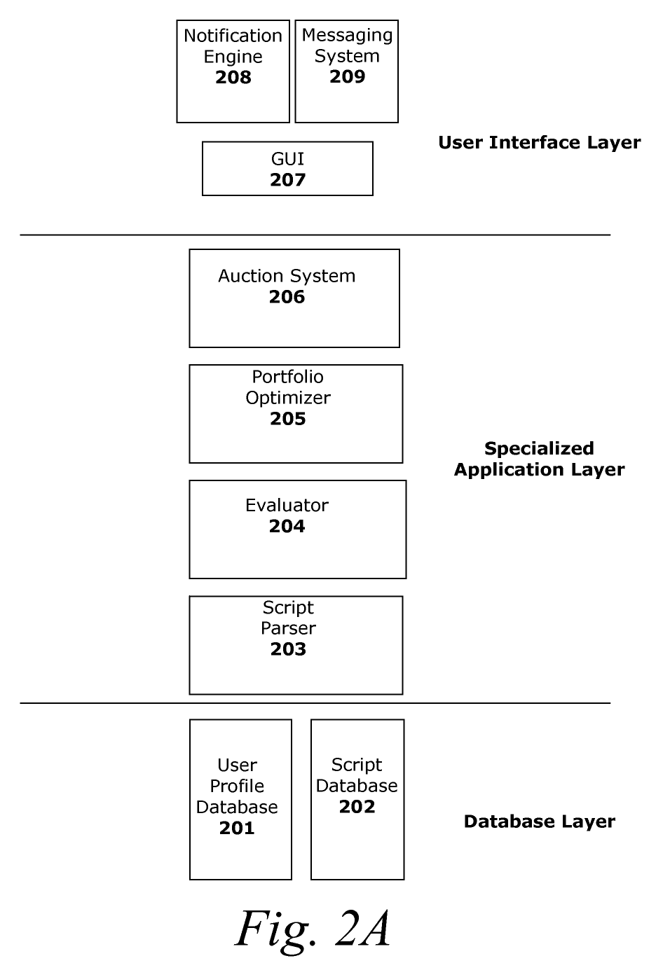

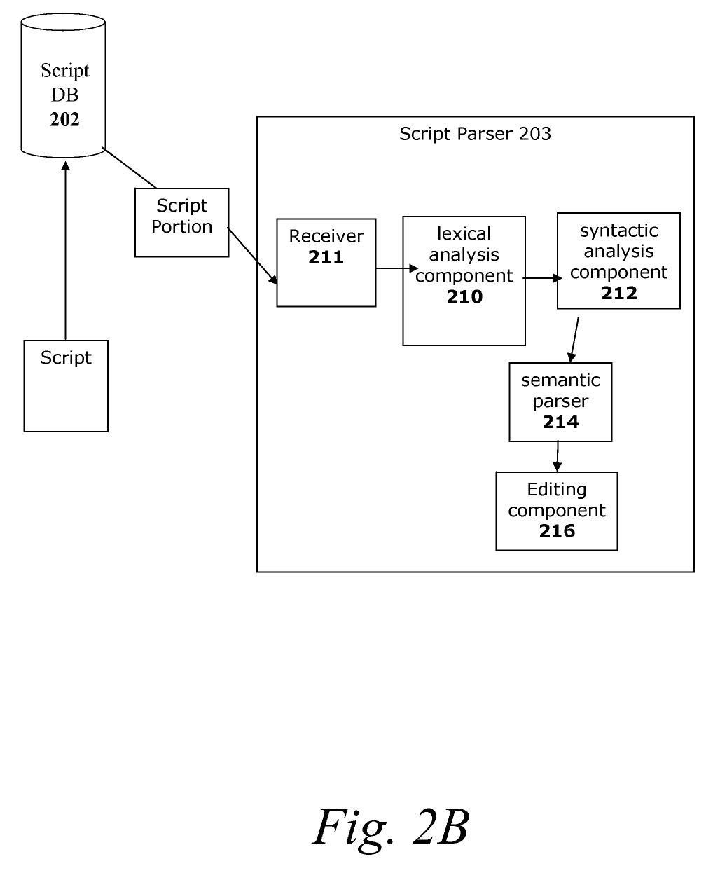

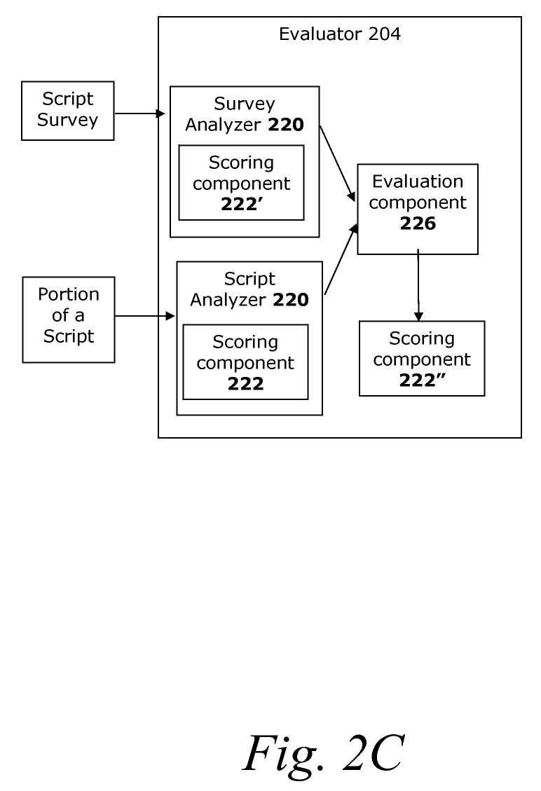

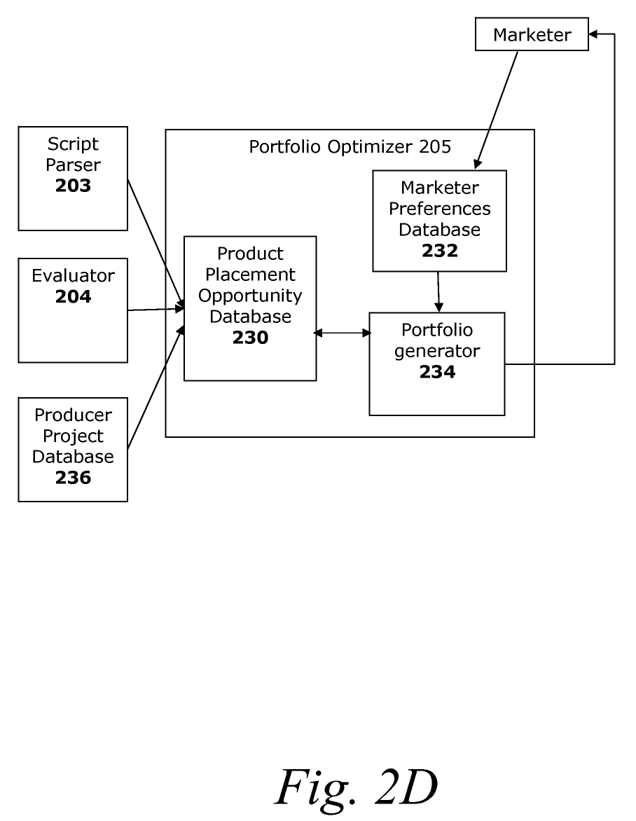

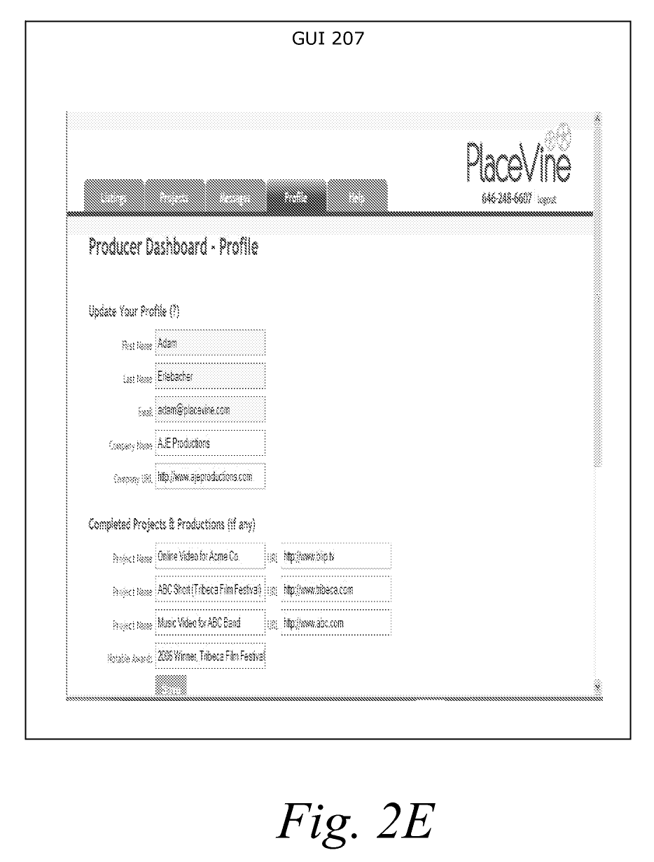

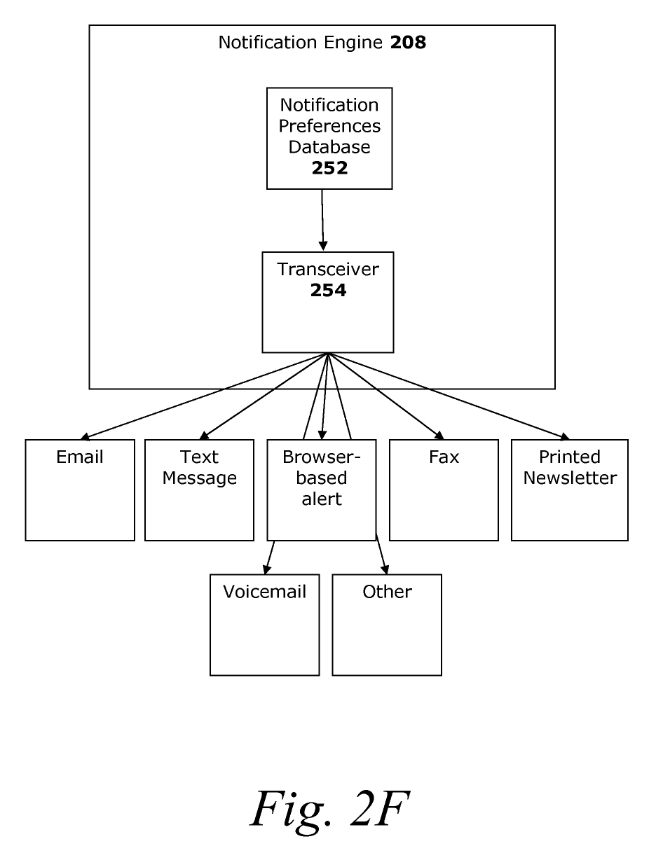

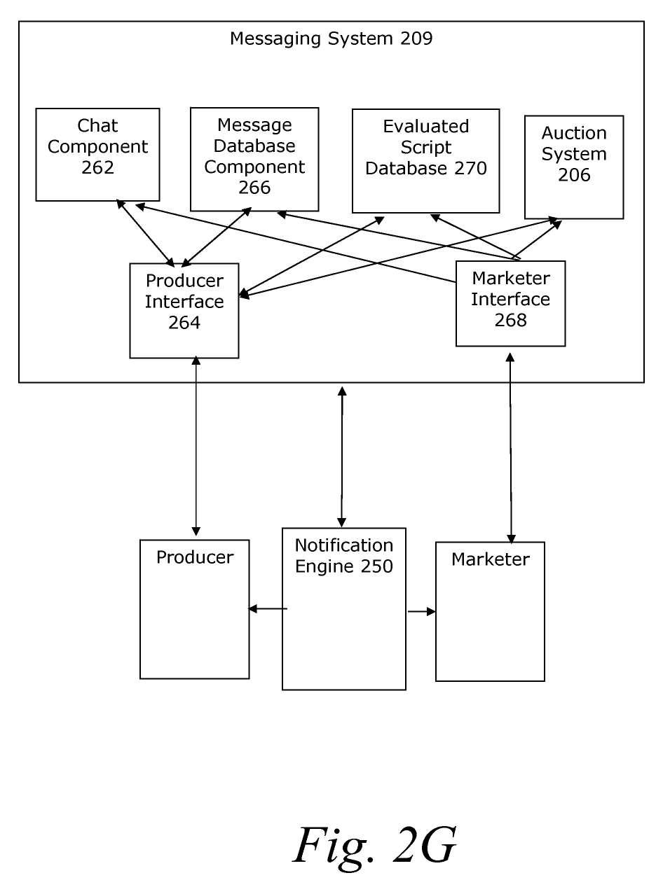

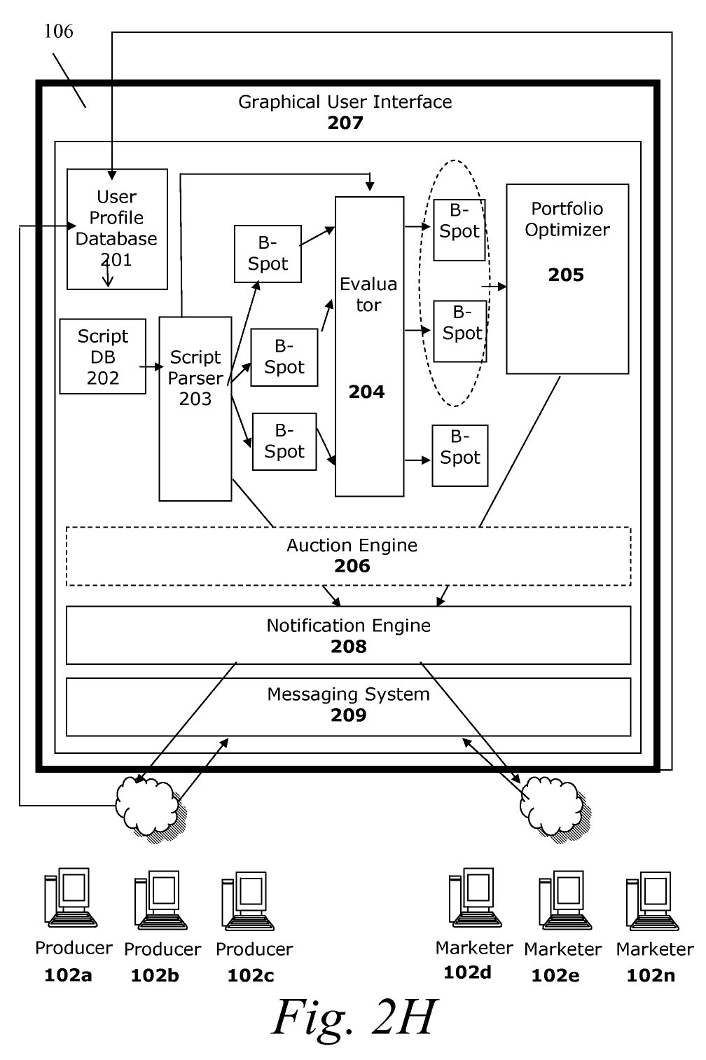

Referring now to FIG. 2A, a block diagram depicts one embodiment of a system for identifying and evaluating brand integration (i.e. product placement) transactions in scripted entertainment. In brief overview, the system includes a database that stores marketer and producer profile information (“User Profile Database 201”); a database (“Script Database 202”) that stores producers' text- or audio-based manuscripts (“Scripts”); a script parser (“Script Parser 203”) that uses natural language processing and other automated techniques to identify brand integration opportunities (“product placements”) in scripts, as well as automated techniques for editing identified brand integration opportunities; an evaluation component applying an algorithm that uses natural language parsing techniques, questionnaire answers, and historical performance data (e.g. box office revenue, internet “views”, etc.) to predict the popularity of a script (“Evaluator 204”); a portfolio optimization component that applies an algorithm based on finance theory and generates a risk-diversified product placement portfolio for marketers, based on each marketer's risk preferences (“Portfolio Optimizer 205”); an auction-based or similar economic mechanism that facilitates the buying, selling, trading, or optioning of product placements (“Auction System 206”); a web-based graphical user interface for marketers and producers to interact with the system (“GUI 207”); a notification engine that alerts marketers and producers about events in the system (“Notification Engine 208”); and a messaging system that facilitates communication between marketers and producers (“Messaging System 209”). In one embodiment, the system, or components of the system will be delivered as a web-based service and accessed remotely via a web browser. In another embodiment, the system, or components of the system will be installed on a local area network and run in a closed environment for an individual client or group of clients. Although only one of each of the components is shown in FIG. 2A, it should be understood that the system may provide multiple ones of any or each of those components, and that in some embodiments, not all components are provided by the system. In some embodiments, for example, a component such as the auction system 206 may be provided as a separate component or, alternatively, not provided at all.

Companies that seek to integrate their brands into scripted entertainment typically hire a product placement agency, public relations firm, or similar agent to represent their brand to producers. Separately, some companies seek brand integration opportunities without the assistance of an agent. The agencies operate by leveraging their relationships with movie studios, television producers, and other members of the producer community to discover and evaluate brand integration opportunities for their clients. Transactions are typically consummated between an advertising agency or brand marketer (“Marketer”), and a writer, producer or otherwise creator of scripted entertainment (“Producer”). In one embodiment, the present disclosure relates to methods and systems for automatically identifying brand integration opportunities (“product placements”) within scripts using natural language processing (NLP) techniques, among others; for evaluating product placements using an algorithm to predict the success of a script and the product placements therein; and for optimizing marketer product placement investments by assembling diversified product placement portfolios based on marketer-specific risk preferences. In one embodiment, the system provides marketers with transparency into brand integration opportunities. In another embodiment, the system provides producers with access to a larger number of brand marketers than they would by partnering with any one agency.

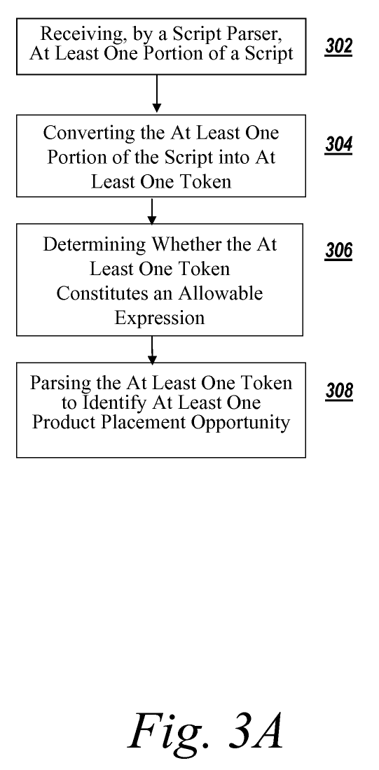

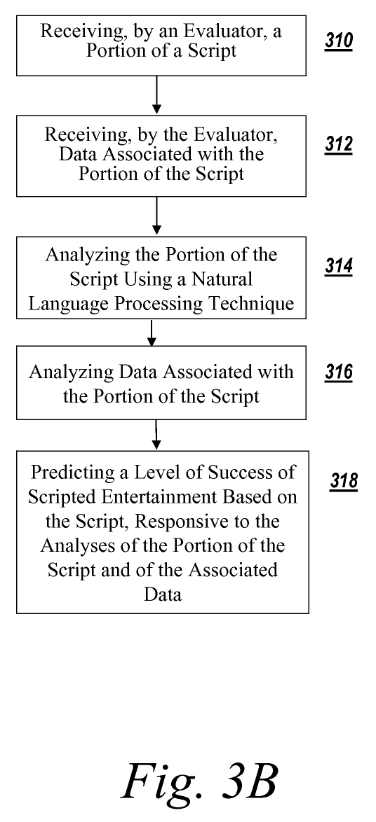

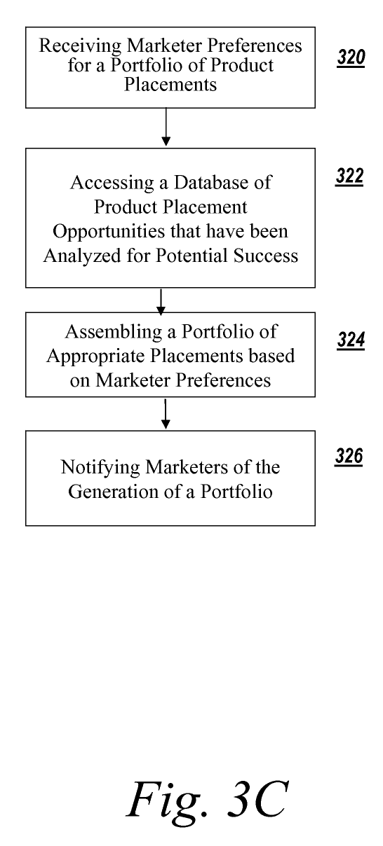

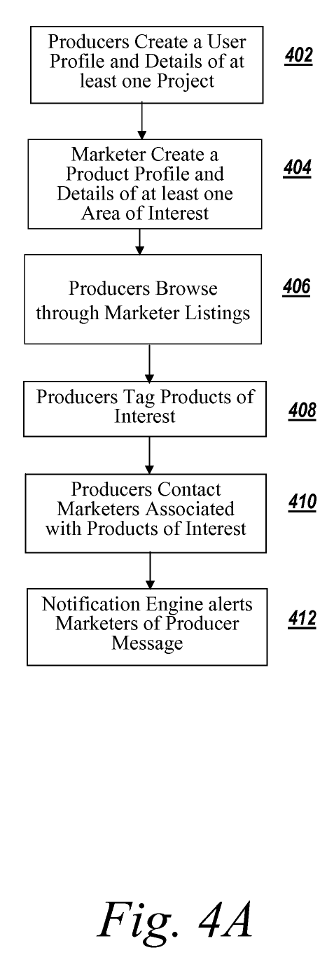

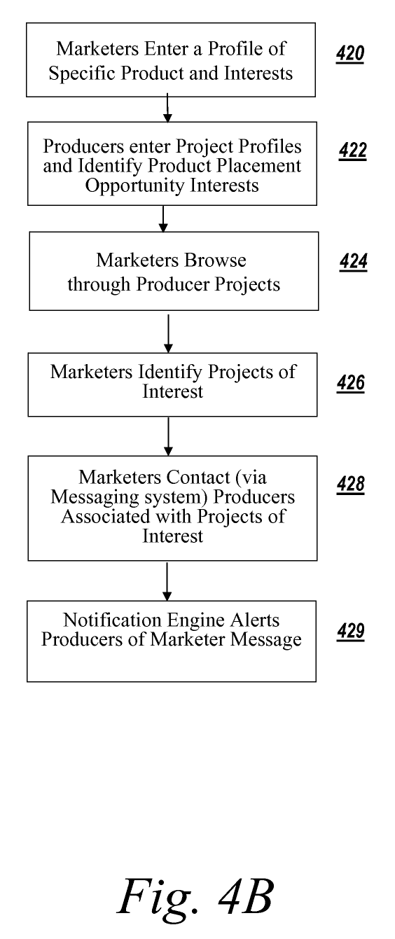

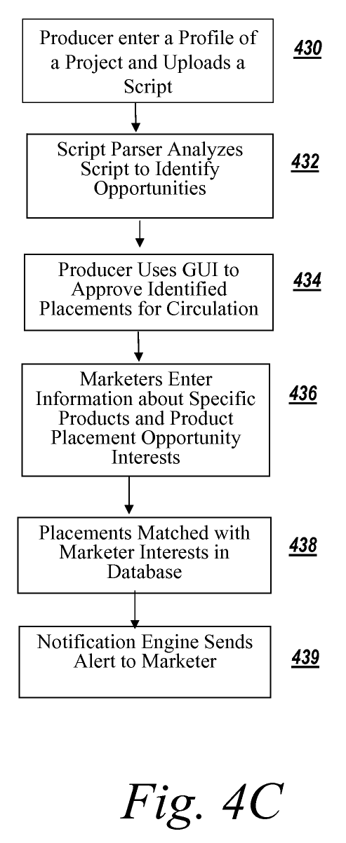

Referring now to FIG. 2A, and in conjunction with FIGS. 3A-4C, the user profile database 201 is a database that stores marketer and producer profile information. In one embodiment, data stored in the user profile database 201 and associated with a marketer includes, without limitation, contact information, information about the marketer's product(s), and other profile data. In another embodiment, data stored in the user profile database 201 and associated with a producer might include contact information, information about past projects, and other background information. In still another embodiment, the user profile database 201 provides an information source and directory made directly available to marketers and producers. In still even another embodiment, the user profile database 201 supports the automated search and identification of potential marketer-producer relationships. In yet another embodiment, the user profile database 201 provides an information source to aid marketers and producers in evaluating product placement decisions. In some embodiments, the user profile database 201 includes a graphical user interface displaying interface elements to a user, such as a marketer or producer, allowing the user to search for data stored within the user profile database 201.

The script database 202 is a database that stores producer scripts. In one embodiment, the script database 202 provides the source material from which the script parser will identify product placement opportunities. In another embodiment, the script database 202 is an information repository allowing producers to manage product placement opportunities and store in-line comments about these opportunities. In still another embodiment, the script database 202 stores a script in its entirety. In still even another embodiment, the script database 202 stores a portion of a script. In still another embodiment, the script database 202 stores an annotated version of a script, such as a script including comments about product placement opportunities entered by either a marketer or a producer. In yet another embodiment, the script database 202 stores a summary of a script. In some embodiments, scripted entertainment includes, but is not limited to, filmed entertainment such as feature-length films, short films, short videos uploaded to the internet (“web videos”), short “viral” web videos, television programming, and other media such as podcasts and other forms of entertainment written prior to performance. In other embodiments, scripted entertainment includes, but is not limited to, live entertainment, such as plays and musicals.

In one embodiment, the user profile database 201 and the script database 202 store data in an ODBC-compliant database. For example, the user profile database 201 or the script database 202 may be provided as an ORACLE database, manufactured by Oracle Corporation of Redwood Shores, Calif. In another embodiment, the user profile database 201 and the script database 202 can be a Microsoft ACCESS database or a Microsoft SQL server database, manufactured by Microsoft Corporation of Redmond, Wash. In still another embodiment, the user profile database 201 and the script database 202 may be a custom-designed database based on an open source database such as the MYSQL family of freely-available database products distributed by MySQL AB Corporation of Uppsala, Sweden, and Cupertino, Calif.

The script parser 203 identifies product placement opportunities in scripts. In one embodiment, the script parser 203 includes a receiver 211 for receiving at least a portion of script. In another embodiment, the receiver 211 includes a component that converts scripts from one of a plurality of formats into a format accepted by at least one of the evaluation component 204 and the script parser 203. In still another embodiment, the receiver 211 includes a speech-to-text engine that converts audio-based scripts into text. In still even another embodiment, the receiver 211 includes a component that converts electronic file formats such as ADOBE PDF's, MICROSOFT Word documents, Word Perfect documents, and Final Draft documents into a format accepted by the script parser 203. In yet another embodiment, the receiver 211 includes a scanning component that converts physical media such as paper-based scripts into a format accepted by the script parser 203.

In one embodiment, the script parser 203 includes a regular expression component converting the at least one portion of the script into at least one token through the use of regular expressions. In another embodiment, the script parser 203 includes an analysis component determining whether the at least one token constitutes an allowable expression. In yet another embodiment, the script parser 203 includes a semantic parsing component parsing the at least one token to identify at least one product placement opportunity.

Referring now to FIG. 2B, a block diagram depicts one embodiment of a system in which the script parser includes a lexical analysis component 210, a syntactic analysis component 212, a semantic parser 214, and an editing component 216. In one embodiment, the lexical analysis component 210 converts a first portion of a script into at least one token. In another embodiment, the lexical analysis component 210 converts a first portion of a script into at least one regular expression. In still another embodiment, the lexical analysis component 210 converts a first portion of a script into at least one token including a regular expression. In yet another of these embodiments, the lexical analysis component 210 converts a script into a plurality of tokens. In some embodiments, the lexical analysis component 210 is a commercial, off-the-shelf product. In one of these embodiments, the commercial product is modified for use with the script parser 203. In other embodiments, the lexical analysis component 210 is developed specifically for the use with the script parser 203. In further embodiments, the lexical analysis component 210 receives at least one portion of a script and generates at least one token, responsive to an analysis of the received at least one portion of the script.

In other embodiments, the script parser 203 includes a syntactic analysis component 212. In one of these embodiments, the syntactic analysis component 212 receives at least one token from the lexical analysis component 210. In another of these embodiments, the syntactic analysis component 212 includes at least one rule for determining whether a received token is an allowable expression. In some embodiments, an allowable expression includes an expression satisfying a rule. In one of these embodiments, the rule requires that the expression have a format accepted by a parser. In another of these embodiments, the syntactic analysis component 212 applies a rule to the received token to format the received token for parsing.

The script parser 203 includes a semantic parser 214 parsing the at least one token to identify a product placement opportunity. In one embodiment, semantic parsing is used to identify products, places, services, emotions, dialogue or other product placement opportunities within a script. In another embodiment, the script parser 203 includes semantic parsing rules (which may be referred to as “modules”) that are used by the semantic parser 214 to identify category-specific products, places, services, emotions, dialogue or other product placement opportunities within a script. In still another embodiment, the semantic parser 214 applies a module to a token to identify a product placement opportunity within the token. In yet another embodiment, the semantic parser 214 determines whether the token includes a word or type of word specified by the module to determine whether a product placement opportunity exists. For example, in one embodiment, a marketer interested in product placement opportunities for breakfast cereals will employ a module identifying products, places, services, emotions, dialogue or other relevant product placement opportunities within the script. The breakfast-cereal module would enable the semantic parser 214 to identify a match within a token(s) or other string analyzed by the semantic parser and text within the module indicative of products, places, services, emotions, dialogue or other breakfast-cereal-related product placement opportunities. A more specific example may include the module identifying scenes involving mention of a specific breakfast cereal brand or generic mention of cereal in the script, scenes involving breakfast or a grocery store, or scenes mentioning a character's hunger or other physical, intellectual or emotional association with breakfast cereal. In some embodiments, the semantic parser 214 applies a rule to the formatted token and identifies a product placement opportunity within the analyzed at least one portion of the script.

In some embodiments, the identified product placement opportunities is an opportunity to modify a script to include a reference to a specific product, such as a particular brand of good rather than a generic category of good. In other embodiment, the identified product placement opportunities are an opportunity to modify a script so that it specifies the use of an actual physical product when performing the scripted entertainment.

In one embodiment, the identified product placement opportunities are approved by a producer and then displayed to a marketer. In some embodiments, the producer accesses an editing component 215 to modify an identified product placement opportunity. In one of these embodiments, the editing component 215 includes an interface allowing the producer to view, edit, manually add, and approve the identified product placements.

In one embodiment, the identified product placement opportunities are approved by a producer and emailed to a marketer. In still another embodiment, the identified product placement opportunities are approved by a producer and sent via text message or other wireless delivery means to a marketer. In still even another embodiment, the identified product placement opportunities will be sent to a marketer using the system's internal messaging component, described in greater detail below. In yet another embodiment, the identified product placement may be assembled into a portfolio using the Evaluator 204 and the portfolio of product placement opportunities may then be sent to a marketer using email, text messaging, other wireless delivery mechanisms, and/or the system's internal messaging component.

Referring back to FIG. 2A, the evaluator 204 predicts the success of a product placement in scripted entertainment (such as a filmed production) based on information derived from an analysis of the script and from data associated with the script. In one embodiment, the evaluator 204 analyzes at least a portion of a script to predict a level of success of a piece of the scripted entertainment. In another embodiment, the evaluator 204 predicts “success” along a number of different metrics including, but not limited to, the predicted number of people who will see the product placement and the estimated advertising impact of the product placement given a certain placement of the advertisement in the material. In still another embodiment, the evaluator 204 determines a level of success of the scripted entertainment by analyzing data associated with the script including the results of a pre-defined set of survey questions. In still even another embodiment, the evaluator 204 determines a level of success of the scripted entertainment by analyzing historical performance data that includes, but is not limited to, box office revenues, internet “views”, and audience survey data to predict the popularity of a script. In some embodiments, the evaluator 204 accesses customized frameworks specific to estimating the impact of product placement investments to generate the prediction of success. In one of these embodiments, the evaluator 204 accesses a framework based upon generic models for predicting the success of scripted entertainment and customized to generate a prediction specific to the impact of a product placement investment.

Referring now to FIG. 2C, a block diagram depicts one embodiment of an evaluation component. The evaluation component includes a script analyzer 220, a survey analyzer 224, an evaluation component 226, and at least one scoring component.

In one embodiment, the script analyzer 220 receives at least one portion of a script. In another embodiment, the script analyzer 220 receives the at least one portion of the script from a script parser 203. In still another embodiment, the script analyzer 220 receives the at least one portion of the script from the script database 202. In still even another embodiment, the script analyzer 220 uses natural language parsing techniques to identify certain words and phrases in the at least one portion of a script that indicate relevant categories, including, but not limited to, levels of action, levels of emotion, and context. In some embodiments, the presence (or lack thereof) of certain categories of words or phrases in the at least one portion of the script, and their frequency, will be analyzed against known successful patterns in order to assign a numerical score representing the potential success of placement in the specific piece of entertainment. In one of these embodiments, the script analyzer 220 includes a scoring component 222 to assign the numerical score.

In one embodiment, the survey analyzer 224 receives at least one response to a questionnaire. In another embodiment, the survey analyzer 224 receives a response to a detailed questionnaire (script survey) providing quantifiable, or binary, responses for each script. The answers provided will be analyzed against known successful patterns of answers in order to generate a numerical score representing the potential success of placement in the specific piece of entertainment. The questionnaire score will then be combined with the natural language score to create an overall score or evaluation for the projected success of a product placement investment in the piece of entertainment.

In one embodiment, the evaluation component 226 generates a prediction of a level of success of a production based on the script, responsive to the analyses of the portion of the script and of the associated data. In another embodiment, the evaluation component 226 generates a prediction of a level of success of a production based on the script, responsive to the assigned score. In still another embodiment, the evaluation component 226 transmits, to a portfolio generation component, the generated prediction. In yet another embodiment, the evaluation component 226 transmits, to a producer of the production based on the script, the generated prediction.

Referring back to FIG. 2A, the portfolio optimizer 205 recommends portfolios of product placement opportunities in a wide variety of media properties (film, television programs, internet videos, music videos, mobile content, and other available live or filmed entertainment) in a manner that attempts to generate a specific, overall level of return at a given level of risk. “Return” may be defined as overall audience views, targeted audience impact, or other metrics defined in conjunction with Marketers. “Risk” will mean the variability of a projected return and may differ across media types, genres, and targeted demographics.

Referring now to FIG. 2D, a block diagram depicts one embodiment of a portfolio optimizer. The portfolio optimizer 205 includes a product placement opportunity database 230, a marketer preferences database 232, a portfolio generator 234, and a producer project database 236. The portfolio optimizer 205 generates a portfolio including an identification of a script responsive to a generated prediction of the level of success of a production including at least a portion of the script and an identified brand integration opportunity.

In one embodiment, the product placement opportunity database 230 is a database that stores identified product placement opportunities and their respective scores as assigned by the evaluator 204. In some embodiments, the product placement opportunity database 230 stores an identification of a script identified by a script parser 203. In other embodiments, the product placement opportunity database 230 stores an identification of a script identified by an evaluator 204. In still other embodiments, the product placement opportunity database 230 includes an identification of a script received from a producer project database 236. In one of these embodiments, a producer adds, removes, or modifies a script stored by the producer project database 236. In yet other embodiments, the product placement opportunity database 230 stores an association between at least one score and an identified script. In one of these embodiments, the product placement opportunity database 230 stores an association between a score assigned by the script parser 203, a score assigned by an evaluator, and an identification of a script. In another of these embodiments, the product placement opportunity database 230 stores a listing of scripts containing potential product placement opportunities and their scores as assigned by at least one of the script parser 203 and the evaluator 204.

In one embodiment, the marketer preferences database 232 is database that stores marketer preferences regarding content and product placement opportunity risk-levels that are used to assemble portfolios of product placement opportunities specific to that marketer. In another embodiment, the marketer preferences databases 232 stores a marketer-specified range of risk scores associated with a script for which the marketer wishes to receive a notification; if a script receives a risk score within the range specified, the marketer should receive an identification of the script. In still another embodiment, the marketer preferences databases 232 stores a marketer-specified maximum risk level associated with a script for which the marketer wishes to receive a notification; if a script receives a risk score less than or equal to the maximum risk level, the marketer should receive an identification of the script. In still even another embodiment, the portfolio optimizer 205 includes a graphical user interface with which a marketer may interact to add, remove or modify data stored in the marketer preferences database 232. In yet another embodiment, the portfolio generator 234 assembles product placement opportunities according to their respective scores in order to create a risk-adjusted portfolio of product placement opportunities.

In some embodiments, the portfolio optimizer 205 analyzes a plurality of product placement opportunities in the product placement opportunity database 230. In one of these embodiments, the opportunities are those identified by the script parser 203. In another of these embodiments, the opportunities are identified by content producers. In still another of these embodiments, marketers will provide parameters by which to derive this select content pool. In still another of these embodiments, utilizing algorithms based on finance theory and portfolio optimization models, the portfolio optimizer 205 assembles a risk-diversified set of product placement opportunities for a marketer based on a preference associated with the marketer. In still even another embodiment, this portfolio is displayed to a user, such as a marketer, via a graphical user interface (GUI) for further review and for use in communication with other users, such as producers. In yet another embodiment, users, such as marketers, may be notified via the notification engine that there are portfolios available for viewing.

Referring now to FIG. 2E, a screen shot depicts one embodiment of a graphical user interface displaying to a user information associated with a product placement opportunity within a script The graphical user interface 207 allows marketers and producers to interact with the system. In one embodiment, a user accesses the graphical user interface 207 via a computing device 100 as described in connection with FIGS. 1A-1B. In another embodiment, the graphical user interface 207 includes an application interface element through which the user accesses various functionality provided by the system, inputs personal data and contact information, uploads content, manages profile information, communicates with other users and views information and output provided by the system.

Referring now to FIG. 2F, a block diagram depicts one embodiment of a notification engine alerting users to product placement opportunities. In one embodiment, the notification engine 208 includes a notification preferences database 252. In another embodiment, the notification engine 208 includes a transceiver 254 communicating notifications and alerts to users based upon user preferences stored in the notification preferences database 252.

In one embodiment, the notification engine 208 transmits, to a user, a notification of a newly-identified product placement opportunity. In another embodiment, the notification engine 208 transmits, to a user, a notification of a newly-generated portfolio of product placement opportunities, including the generation of a portfolio optimized according to a risk tolerance level of the user. In still another embodiment, the notification engine 208 notifies a user, such as a marketer, of product placement opportunities identified by the script parser 203, the evaluator 204, or of portfolios of product placement opportunities identified by the portfolio optimizer 205. In yet another embodiment, the notification engine 208 notifies a user, such as a producer, of product placement opportunities identified by the script parser 203, the evaluator 204, or of portfolios of product placement opportunities identified by the portfolio optimizer 205.

In one embodiment, the notification engine 208 transmits a notification to a user via email, text message, voicemail, printed newsletter, fax, browser-based alert, or any other means of communications available. In another embodiment, the notification engine 208 includes a graphical user interface that allows users to specify how and when they are notified by the notification engine. In still another embodiment, the notification engine 208 retrieves data stored by the system and received from the user via a graphical user interface 207. In some embodiments, the notification engine 208 includes an off-line component transmitting notifications to users via communications—such as printed, hard-copy newsletters, printed letters customized for each user, or faxes—featuring product placements that have been identified by the system and that may be viewed in greater detail in the system.

Referring now to FIG. 2G, a block diagram depicts one embodiment of a messaging system facilitating communication between content producers and marketers. The messaging system 209 includes a real-time chat component 262, a producer interface 264, a message database component 266, and a marketer interface 268. In some embodiments, the messaging system 209 includes an interface to the notification engine 208.

In one embodiment, the messaging system 209 allows content producers and marketers to compose, edit, delete, transmit and archive electronic communications. In another embodiment, content producers and marketers use the messaging system 209 to organize their respective electronic communications by using methods of tagging, labeling, or foldering, amongst others. In still another embodiment, the messaging system 209 provides a real-time chat component 262 for real-time communication between content producers and marketers using methods including but not limited to instant messaging, text messaging, messaging via chatroom and voice-based electronic communications. In some embodiments, the message database component 266 stores user messages. In other embodiments, the messaging system 209 includes customized interfaces for different types of users. In one of these embodiments, the producer interface 264 provides an interface for users, such as content producers, interested in identifying marketers who may be interested in placing advertising in content produced by the user. In another of these embodiments, the marketer interface 268 provides an interface for users, such as marketers, interested in identifying content producers who may be interested in allowing the marketer to place advertisements in content. In still another of these embodiments, the notification engine 208 provides to users, such as marketers or producers, an identification of a script including a product placement opportunity which may be of interested to the user.

Referring still to FIG. 2G, in some embodiments, the auction system 206 is an auction-based system that facilitates the buying, selling, trading, or optioning of product placements. In one embodiment, the auction system receives a script and an identification of at least one product placement opportunity within the script. In another embodiment, the auction system 206 stores the received script and the received identification of at least one product placement opportunity within the script in an evaluated script database 270. In still another embodiment, the auction system 206 includes a user interface allowing a user, such as a marketer or content producer, to place a bid or an offer for purchase of a product placement opportunity. In some embodiments, the auction system 206 supports the auctioning of product placement opportunities to a highest-bidder in a plurality of bidders. In other embodiments, the auction system 206 supports the sale of a product placement opportunity to a user.

Referring now to FIG. 2H, a block diagram depicts one embodiment of a system for identifying and evaluating brand integration transactions in scripted entertainment. In one embodiment, the system includes a User Profile Database 201 storing marketer and producer profile information as described in FIG. 2A. In another embodiment, the user profile database 201 provides an information source and directory made directly available to marketers and producers. In still even another embodiment, the user profile database 201 supports the automated search and identification of potential marketer-producer relationships. In yet embodiment, a script database 202 stores producers' text- or audio-based scripts as described above in connection with FIG. 2B.

In one embodiment the script parser 203 uses natural language processing and other automated techniques to identify and modify product placement opportunities in scripts as described above in connection with FIG. 2B. In another embodiment, the evaluator 204 then applies an algorithm that uses natural language parsing techniques, questionnaire answers, and historical performance data (e.g. box office revenue, internet “views”, etc.) to predict the popularity of a script and/or its respective product placement opportunities as described in FIG. 2C. In another embodiment, the portfolio optimizer 205 applies an algorithm based on modern finance theory to analyze the product placement opportunities scored by the evaluator 204 to generate a risk-diversified portfolio of product placement opportunities, specific to each marketer's risk preferences as illustrated in FIG. 2D. In still another embodiment, the auction system 206 facilitates the buying, selling, trading, or optioning of product placement opportunities as identified, scored, and assembled by one or all of the script parser 203, evaluator 204, and portfolio optimizer 205, respectively, as described above in connection with FIG. 2G. In still even another embodiment, marketers and producers interact with the graphical user interface GUI 207 and receive alerts regarding system activities via the notification engine 208 that alerts marketers or producers about events in the system. In yet another embodiment, a marketer or producer initiates communication or responds to an alert received by the Notification Engine 208 by sending messages in the system via the Messaging System 209 as described above in connection with FIG. 2G.

Referring now to FIG. 3A, a flow diagram depicts one embodiment of a method for parsing a script to identify a brand integration opportunity within scripted entertainment. In brief overview, the method includes receiving, by a script parser, a script (302). The method includes converting the at least one portion of the script into at least one token (304). The method includes determining whether the at least one token constitutes an allowable expression (306). The method includes parsing the at least one token to identify at least one product placement opportunity (308).

Referring still to FIG. 3A and in greater detail, a script parser receives a script (302). In one embodiment, the script parser 203 receives the script in digital form. In another embodiment, the Script may be uploaded to the script parser 203 via the internet. In another embodiment, the Script may be uploaded to the script parser 203 from a storage device such as a CD-ROM, DVD, or USB device. In another embodiment, the Script may be manually transcribed into the script parser 203.

The Script Parser converts the at least one portion of the script into at least one token (304). In one embodiment, the script parser performs lexical analysis to convert the script into formal representations of text, referred to as tokens. In another embodiment, these tokens are identified using regular expressions. Since the purpose of the script parser is to identify product placements, the regular expressions include rules that, when identifying tokens, may for example ignore generic articles of speech such as “the” or other linguistic elements that are extraneous to identifying product placements.

The script parser performs syntactic analysis to determine whether the at least one token constitutes an allowable expression (306). The script parser performs both “top-down” and “bottom-up” analysis of the text input to determine whether the token constitutes an allowable expression. For example, and in some embodiments, syntactic analysis might disregard expressions including symbols such as “*” that do not provide information relevant to subsequent processing of the script (i.e. semantic parsing).

The script parser parses the at least one token to identify at least one product placement opportunity (308). Semantic parsing will be used to identify products, places, services, emotions, dialogue or other product placement opportunities within a Script. In one embodiment, the script parser 203 will use keyword search systems that employ lexical analysis, regular expressions, and other computational methods to identify product placement opportunities within scripts. In another embodiment, the script parser 203 will use Natural Language Processing (NLP)—a subset of computer science within computational linguistics—employing stochastic, probabilistic, and/or statistical techniques to identify product placements within Scripts. These techniques might include the use of machine learning, neural nets, probabilistic context-free grammars, maximum entropy, corpora models, and Markov models.

The script parser 203 includes semantic parsing rules (“Modules”) that are used by the semantic parser to identify category-specific products, places, services, emotions, dialogue or other product placement opportunities within a script. For example, a marketer that has signaled his interest via the user profile database 201 in product placement opportunities for breakfast cereals will employ a module able to identify products, places, services, emotions, dialogue or other relevant breakfast-cereal product placement opportunities within the script. The breakfast-cereal module would enable the script parser 203 to match on token(s) or other strings indicative of products, places, services, emotions, dialogue or other breakfast-cereal-related product placement opportunities. A more specific example may include the module identifying scenes involving specific mention of a breakfast cereal brand or generic mention of cereal in the script, scenes involving breakfast or a grocery store, mention of a character's hunger or other physical, intellectual or emotional association with breakfast cereal.

The script parser 203 in concert with the relevant module(s), will output a list of product placement opportunities that may be approved and/or edited by the producer who originally uploaded the script. Once approved, the producer submits the product placement opportunities which are in turn made available to the marketers as described above in connection with FIG. 2G. Marketers may then view the list of product placement opportunities using the GUI 207 and contact the relevant producer using the Messaging System 209.

Referring now to FIG. 3B, a flow diagram depicts one embodiment of a method for parsing a script to predict a level of success of a scripted entertainment based on the script. In brief overview, the method includes receiving, by an evaluation component executing on a computing device, a portion of a script (310). The method includes receiving, by the evaluator, data associated with the contents of the script (312). The method includes analyzing, by the evaluation component, the portion of the script using a natural language processing technique (314). The method includes analyzing, by the evaluation component, data associated with the contents of the script (316). The method includes generating, by the evaluation component, a prediction of a level of success of a scripted entertainment based on the script, responsive to the analyses of the portion of the script and of the associated data (318).

Referring now to FIG. 3B, and in greater detail, the evaluator 204 receives a portion of a script from the script parser 203 (310). In one embodiment, the portion of the script received by the evaluator 204 from the script parser 203 may include product placement opportunities identified by the script parser 203. In another embodiment the evaluator 204 receives a script or a portion of a script from the script database 202.

The evaluator 204 analyzes the script or portion of the script using one or more natural language processing techniques (314). In one embodiment, the evaluator 204 uses natural language processing techniques to identify certain words and phrases that indicate relevant categories, including, but not limited to, levels of action, levels of emotion, and context. The presence or absence of certain categories of words of phrases, and their frequency, will be analyzed against known successful patterns in order to assess the potential success of a product placement in the specific piece of entertainment. As a result, the natural language processing technique(s) provide(s) a score to the script, portion of the script, or product placement opportunity based on the variables described above.

The evaluator receives data associated with the portion of the script (312). In one embodiment, at least one response to a detailed questionnaire, containing quantifiable, or binary, responses, will be requested for each script. In some embodiments, the questionnaire asks for data which a natural language processing technique might not identify in an analysis of the script.

The evaluator analyzes the data associated with the content of the script (316). In one embodiment, the data provided in response to the questionnaire will be analyzed against known successful patterns of answers in order to quantitatively assess the potential success of placement in the specific piece of entertainment. In another embodiment, the questionnaire results will be assigned a score related to the predictive success of the specific piece of entertainment. In still another embodiment, the questionnaire score will be combined with the natural language processing score to create an overall evaluation or numerical score for the projected success of a product placement investment in the piece of entertainment.

The evaluator 204 predicts a level of success of a scripted entertainment based on the script, responsive to the analyses of the portion of the script and of the associated data (318). In one embodiment, the evaluator 204 predicts “success” along a number of different metrics including, but not limited to, the predicted number of people who will see the product placement and the estimated advertising impact of the product placement given a certain placement of the advertisement in the material. In another embodiment, the evaluator 204 determines a level of success of the scripted entertainment by analyzing data associated with the script including the results of a pre-defined set of survey questions.

In one embodiment, the evaluator 204 analyzes at least a portion of a script to predict a level of success of a piece of the scripted entertainment. In another embodiment, the evaluator 204 determines a level of success of the scripted entertainment by analyzing historical performance data that includes, but is not limited to, box office revenues, internet “views”, and audience survey data to predict the popularity of a script. In some embodiments, the evaluator 204 accesses customized frameworks specific to estimating the impact of product placement investments to generate the prediction of success. In one of these embodiments, the evaluator 204 accesses a framework based upon a generic model for predicting the success of scripted entertainment and customized to generate a prediction specific to the impact of a product placement investment.

In one embodiment, a producer creates a user profile, a profile of a production company, and a description of a current project opportunity. In another embodiment, the producer uploads, to the system for evaluation, a script linked to this project opportunity. In still another embodiment, the producer, or a user associated with the user, answers a web-based survey of specific questions giving further specifics on the project content. In still even another embodiment, the evaluator 204 analyzes the script using various natural language processing conventions, including, but not limited to, a bag-of-words model for identifying word frequency. In another embodiment, the evaluator 204 combines the information contained in the producer survey with statistical information generated from the analyses of the script and executes a regression analysis of this information against historical performance data to predict the performance of the script (and standard deviation) and/or the specific product placements identified in by marketers. In still another embodiment, the evaluator 204 transmits, to a portfolio generation component, the generated prediction. In yet another embodiment, the evaluator 204 transmits, to a producer of the production based on the script, the generated prediction.

In one embodiment, the portfolio generation component generates a portfolio including an identification of the script responsive to the received prediction of the level of success. In another embodiment, the portfolio generation component receives an identification of a brand integration opportunity within the portion of the script. In still another embodiment, the portfolio generation component generates a portfolio including an identification of the script responsive to the received prediction of the level success and to the received identification of the brand integration opportunity.

Referring now to FIG. 3C, a flow diagram depicts one embodiment of a method for generating a portfolio of product placement opportunities. In brief overview, the method includes receiving marketer preferences for a portfolio of product placements (320). The method includes accessing a database of product placement opportunities that have been analyzed for potential success (322). The method includes assembling a portfolio of appropriate placement opportunities based on marketer preferences (324). The method includes notifying marketers of the generation of a portfolio (326).

In one embodiment, the portfolio optimizer analyzes product placement opportunities stored in the product placement opportunity database 230. These product placement opportunities may be those identified by the script parser 203 or those manually inputted by content producers, among other methods. In another embodiment, the product placement opportunities have been scored by the evaluator 204 as described in FIG. 2C. Marketers will provide parameters—such as risk tolerance levels or subject matter of interest to the marketer—by which to identify a script of interest to the marketer. Utilizing algorithms based on finance theory and portfolio optimization models, the portfolio optimizer will assemble a risk-diversified set of product placement opportunities for marketers based on each marketer's preferences. This portfolio will be displayed in the system's web-based (or otherwise) graphical user interface (GUI) for further review and communication with producers. Marketers may be notified via the notification engine that there are portfolios available for viewing.

A method includes receiving by a portfolio optimization component (such as the portfolio optimizer) executing on a computing device 100, from a user (such as a marketer or a producer), at least one identification of a user preference for a type of product placement opportunity. The method includes retrieving, by the portfolio optimization component, from a database of product placement opportunities that have been analyzed for potential success, at least one identification of a product placement opportunity satisfying the at least one identification of the user preference. The method includes generating, by the portfolio optimization component, a portfolio storing the at least one identification of the product placement opportunities. The method includes transmitting, by the portfolio optimization component, to the user, a notification of the generation of a portfolio. In one embodiment, the portfolio optimizer applies an algorithm to generate a risk-diversified portfolio of product placement opportunities. In another embodiment, the portfolio optimizer displays, to a user, a graphical user interface for review of the generated portfolio.

In one embodiment, a marketer will use the portfolio of product placement opportunities suggested by the portfolio optimizer to inform her decisions about what product placement opportunities to invest in. In another embodiment, a marketer will direct an agency, on their behalf, to begin negotiations with each of the suggested producers in order to secure placement opportunities. In another embodiment, the marketer will compare the suggested portfolio against a manually constructed portfolio in order to assess gaps. In yet another embodiment, the marketer will use an electronic auction or purchasing system to buy the entire suggested portfolio. In another embodiment, the marketer will use the messaging system to contact the producer responsible for each respective product placement opportunity listed in the portfolio by the portfolio optimizer. In yet another embodiment, the producer will use the system to find marketers interested in providing product placements.

In one embodiment, a portfolio of product placements is recommended to a particular marketer. In another embodiment, a match is identified between a product placement opportunity identified by a script parser 203 to a stated preference of the marketer. In still another embodiment, the popularity prediction and standard deviation derived by the evaluator 204 is used to create a portfolio of product placements that have a predicted popularity at a level of risk as specified by the marketer. In still even another embodiment, the marketer is informed of the generation of these product placement portfolios via the notification engine. In some embodiments, the marketer uses the systems described above in connection with FIGS. 2A-2H to complete the automated purchase of all, or some, of the product placements. In one of these embodiments, a marketer purchases, directly from a producer, a product placement opportunity at a fixed price or through an auction-based or similar economic mechanism. In another of these embodiments, payment for this product placement opportunity may or may not occur online.

Referring now to FIG. 4A, a flow diagram depicting one embodiment of a method for allowing producers to directly contact marketers for the purpose of discussing potential brand integration projects. The method includes creating, by a producer a user profile and provides details of at least one project (402). The method includes creating, by a marketer a product profile and entering details of at least one area of interest (404). The method includes browsing, by a producer, through a plurality of marketer profiles (406). The method includes identifying, by a producer, at least one product of interest (408). The method includes contacting, by a producer, marketers associated with the identified at least one product of interest (410). The method includes alerting, by a notification engine, a marketer of a message from a producer (412). In one embodiment, the marketer and the producer interact with a system as described in FIGS. 2A-2H. In another embodiment, the marketer and the producer review scripts and portfolios and analyzed and generated according to the methods described above in connection with FIGS. 3A-3C

A producer creates a user profile and provides details of at least one project (402). In one embodiment, the producer creates a user profile of the production company with which the producer is affiliated. In another embodiment, the producer provides details of a current project which includes opportunities for product placement.

A marketer creates a product profile and entering details of at least one area of interest (404). In one embodiment, the marketer creates a profile of a specific brand. In another embodiment, the marketer identifies areas of interest to the marketer—for example, by identifying a category of scripts for which the marketer may be able to provide product placements. In still another embodiment, the marketer identifies types of products within scripts for which the marketer may be able to provide product placements.

A producer browses through a plurality of marketer profiles (406). In one embodiment, a producer searches through marketer profiles (utilizing various criteria including, but not limited to, a category of marketer's product (“Category”), free text words (“Tags”) assigned by marketers to products, and the types of economic relationships (“Economics”) that marketers are interested in discussing. In another embodiment, the producer saves an identification of relevant products (408). In still another embodiment, the producer saves personal notes on products that they are interested in via a project management tool (“Flagging”) for later viewing. Producers contact marketers utilizing the messaging system (410). Marketers will be notified through the notification engine that a message has been received on their behalf (412).

Referring now to FIG. 4B, a flow diagram depicting one embodiment of a method for allowing marketers to directly contact producers for the purpose of discussing potential brand integration projects. The method includes creating, by a marketer a product profile and provides details of at least one area of interest (420). The method includes creating, by a producer a project profile and entering details of at least one area of interest (422). The method includes browsing, by the marketer, through a plurality of producer projects (424). In one embodiment, the marketer searches for projects of interest using criteria including but not limited to the content format of the producer's project (“Content Format”), the genre of scripted entertainment (“Genre”), and the production location (“Location). The method includes identifying, by the marketer, at least one project of interest (426). In one embodiment, the marketer saves an identification of relevant products. In another embodiment, the marketer saves personal notes on products that he or she is interested in via a project management tool (“Flagging”) for later viewing. The method includes contacting, by the marketer, a producer associated with the identified at least one project of interest (428). The method includes alerting, by a notification engine, a marketer of a message from a producer (429). In one embodiment, the marketer and the producer interact with a system as described in FIGS. 2A-2H. In another embodiment, the marketer and the producer review scripts and portfolios and analyzed and generated according to the methods described above in connection with FIGS. 3A-3C

Referring now to FIG. 4C, a flow diagram depicting one embodiment of a method for automatically identifying product placements in scripts and notifying marketers of available product placement opportunities. In brief overview, the method includes entering, by a producer, a profile of a project and uploading a script (430). The method includes analyzing, by the script parser, the script to identify product placement opportunities (432). The method includes using, by a producer, a graphical user interface to approve an identified placement opportunity for circulation (434). The method includes entering, by a marketer, information about specific products and product placement opportunity interests (436). The method includes matching a placement opportunity with a marketer interest (438). The method includes notifying, by a notification engine, the marketer of the match (439). In one embodiment, the marketer and the producer interact with a system as described in FIGS. 2A-2H. In another embodiment, the marketer and the producer review scripts and portfolios and analyzed and generated according to the methods described above in connection with FIGS. 3A-3C

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, C#, PROLOG, or any byte code language such as JAVA. The software programs may be stored on or in one or more articles of manufacture as object code.

Having described certain embodiments of methods and systems for automated identification and evaluation of brand integration opportunities in scripted entertainment, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A system for parsing a script to identify brand integration opportunities within scripted entertainment comprising:
a lexical analysis component receiving at least one portion of a script and generating at least one token, responsive to an analysis of the received at least one portion of the script;
a syntactic analysis component receiving the generated token and applying a rule to the generated token to format the generated token for parsing; and
a semantic parser applying a rule to the formatted token, identifying a product placement opportunity within the analyzed at least one portion of the script; and
a notification engine transmitting, to a user, an identification of the product placement opportunity.

2. The system of claim 1, wherein the lexical analysis component includes a translation component translating the at least one portion of the script into a regular expression.

3. The system of claim 1, wherein the semantic parser further comprises means for applying a rule to identify a category of the formatted token.

4. The system of claim 3, wherein the semantic parser further comprises means for determining whether the identified category is associated with an identification of a product placement opportunity.

5. The system of claim 1, wherein the semantic parser further comprises means for identifying an opportunity to modify the analyzed at least one portion of the script to include a reference to a specific product.

6. A method for parsing a script to identify brand integration opportunities within scripted entertainment, the method comprising:
receiving, by a lexical analysis component, at least one portion of a script;
generating, by the lexical analysis component, at least one token, responsive to an analysis of the received at least one portion of the script;
receiving, by a syntactic analysis component, the generated token;
applying, by the syntactic analysis component, a rule to the generated token to format the generated token for parsing;
applying, by a semantic parser, a rule to the formatted token; and
identifying, by the semantic parser, a product placement opportunity within the analyzed at least one portion of the script.

7. The method of claim 6 further comprising translating the at least one portion of the script into a regular expression.

8. The method of claim 6 further comprising applying, by the semantic parser, a rule to identify a category of the formatted token.

9. The method of claim 8 further comprising determining, by the semantic parser, whether the identified category is associated with an identification of a product placement opportunity.

10. The method of claim 6 further comprising identifying, by the semantic parser, an opportunity to modify the analyzed at least one portion of the script to include a reference to a specific product.

11. A method for parsing a script to predict a level of success of a production of scripted entertainment, the method comprising:
receiving, by an evaluation component executing on a computing device, a portion of a script;
analyzing, by the evaluation component, the portion of the script using a natural language processing technique;
analyzing, by the evaluation component, data associated with the portion of the script;
generating, by the evaluation component, a prediction of a level of success of a production based on the script, responsive to the analyses of the portion of the script and of the associated data; and
transmitting, by the evaluation component, to a portfolio generation component, the generated prediction.

12. The method of claim 11 further comprising receiving, by the evaluation component, data associated with the script.

13. The method of claim 11 further comprising identifying, by the evaluation component, a category of an expression in the analyzed portion of the script.

14. The method of claim 13 further comprising analyzing, by the evaluation component, the category is identified as a characteristic of a script categorized as a successful script.

15. The method of claim 11, wherein analyzing, by the evaluation component, data associated with the portion of the script further comprises analyzing a result of a survey completed by a reviewer of the script.

16. The method of claim 11 further comprising assigning, by the evaluation component, a score to the portion of the script.

17. The method of claim 16 further comprising generating, by the evaluation component, a prediction of a level of success of a production based on the script, responsive to the assigned score.

18. The method of claim 11 further comprising generating, by the evaluation component, a prediction of a level of success of a production based on the script, responsive to a prediction of a number of people that will see the production.

19. The method of claim 11 further comprising generating, by the evaluation component, a prediction of a level of impact on a production based on the script of a product placement investment.

20. The method of claim 11 further comprising transmitting, by the evaluation component, to a producer of the production based on the script, the generated prediction.

21. The method of claim 11 further comprising generating, by the portfolio generation component, a portfolio including an identification of the script responsive to the received prediction of the level of success.

22. The method of claim 11 further comprising receiving, by the portfolio generation component, an identification of a brand integration opportunity within the portion of the script.

23. The method of claim 22 further comprising generating, by the portfolio generation component, a portfolio including an identification of the script responsive to the received prediction of the level of success and the received identification of the brand integration opportunity.

24. A system for parsing a script to predict a level of success of a production of scripted entertainment comprising:
means for receiving a portion of a script;
means for analyzing the portion of the script using a natural language processing technique;
means for analyzing data associated with the portion of the script;
means for generating a prediction of a level of success of a production based on the script, responsive to the analyses of the portion of the script and of the associated data; and
means for transmitting, to a portfolio generation component, the generated prediction.

25. The system of claim 24 further comprising means for identifying a category of an expression in the analyzed portion of the script.

26. The system of claim 25 further comprising means for analyzing the category is identified as a characteristic of a script categorized as a successful script.

27. The system of claim 24 further comprising means for analyzing a result of a survey completed by a reviewer of the script.

28. The system of claim 24 further comprising means for assigning a score to the portion of the script.

29. The system of claim 28 further comprising means for generating a prediction of a level of success of a production based on the script, responsive to the assigned score.

30. The system of claim 24 further comprising means for generating a prediction of a level of success of a production based on the script, responsive to a prediction of a number of people that will see the production.

31. The system of claim 24 further comprising means for generating a prediction of a level of impact on a production based on the script of a product placement investment.

32. The system of claim 24 further comprising means for transmitting, to a producer of the production based on the script, the generated prediction.

33. A system for identifying and evaluating brand integration opportunities within scripted entertainment comprising:
a script parser receiving at least one portion of a script and identifying a brand integration opportunity within the received at least one portion of the script;
an evaluation component receiving the at least one portion of the script and predicting a level of success of a production including the at least one portion of the script; and
a portfolio optimization component generating a portfolio including an identification of the script responsive to the generated prediction of the level of success and the identified brand integration opportunity.

34. The system of claim 33 further comprising a script database storing the at least one portion of the script.

35. The system of claim 33, wherein the script parser further comprises a lexical analysis component generating at least one token, responsive to an analysis of the received at least one portion of the script.

36. The system of claim 35, wherein the script parser further comprises a syntactic analysis component applying a rule to the generated token.

37. The system of claim 35, wherein the script parser further comprises a semantic parser identifying a product placement opportunity within the analyzed at least one portion of the script.

38. The system of claim 35, wherein the script parser further comprises a semantic parser applying a rule to the generated token and identifying a product placement opportunity within the analyzed at least one portion of the script.

39. The system of claim 33, wherein the script parser further comprises a translation component translating the at least one portion of the script into a format specified by the evaluation component.

40. A method for generating a portfolio of product placement opportunities, the method comprising:
receiving, by a portfolio optimization component executing on a computing device, from a user, at least one identification of a user preference for a type of product placement opportunity;
retrieving, by the portfolio optimization component, from a database of product placement opportunities that have been analyzed for potential success, at least one identification of a product placement opportunity satisfying the at least one identification of the user preference;
generating, by the portfolio optimization component, a portfolio storing the at least one identification of the product placement opportunities; and
transmitting, by the portfolio optimization component, to the user, a notification of the generation of a portfolio.

41. The method of claim 39 further comprising applying, by the portfolio optimization component, an algorithm to generate a risk-diversified portfolio of product placement opportunities.

42. The method of claim 39 further comprising displaying, by the portfolio optimization component, to the user, a graphical user interface for review of the generated portfolio.
